(19) United States
(12) Patent Application Publication
(10) Pub. No.: US 2012/0230524 A1
(43) Pub. Date: Sep. 13, 2012

(54) PIEZOELECTRIC PANEL SPEAKER

(75) Inventors: Yi-Shun CHANG, Kaohsiung City (TW); Syh-Yuh CHENG, Douliu City (TW)

(73) Assignee: HO HSIN PROGRESSIVE TECHNOLOGY CO., LTD., Taipei City (TW)

(21) Appl. No.: 13/041,676

(22) Filed: Mar. 7, 2011

(51) Int. Cl. H04R 17/00

(52) U.S. Cl. 381/190

(57) ABSTRACT

A piezoelectric panel speaker has a frame, piezoelectric actuators and a vibrating diaphragm set into the hollow assembly space of the frame. Two corresponding sides of the diaphragm are fixed onto the actuator, and the other two corresponding sides are spaced with said frame. The actuator is fixed onto both sides of the diaphragm, high sound pressure is generated by the diaphragm through high deformation of the piezoelectric bimorph plates. The plates of the actuator could be driven independently by the driving voltage. This could reduce the resonance of the diaphragm through the phase of driving voltage. The diaphragm could generate smooth acoustic response. Two corresponding sides of the diaphragm spaced with said frame are linked to said frame via a flexible connector. This could reduce the clamping effect of the frame against the diaphragm, and avoid the reduction of sound pressure arising from amplitude limitation of the vibrating diaphragm.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates generally to a piezoelectric panel speaker, and more particularly to an innovative one which is configured to fasten a piezoelectricity actuator onto a frame for acoustic generation of a vibrating diaphragm. The resonance of the vibrating diaphragm is then inhibited by adjusting the driving voltage polarity of piezoelectric bimorph actuator, thus generating sound of a wide range and high sound pressure for more satisfactory applications.

2. Description of Related Art Including Information Disclosed Under 37 CFR 1.97 and 37 CFR 1.98.

Based on the acoustic vibration, an acoustic generator generally comprises an actuator for powered-driven vibration and a vibrating diaphragm for driving air vibration and acoustic output. In tune with the growing trend of compact electronic products, thin-profile or panel speakers are on a full swing. As conventional moving-coil speakers are restricted by magnetic leakage of the magnetic loop, there is difficulty in developing thin-profile moving-coil speakers. So, how to develop a novel, thin-profile and high-quality speaker with built-in electronics is a technology concern.

By taking piezoelectric plate as an actuator, a piezoelectric panel speaker allows one to bond the metal plate on the actuator, and convert the vibrating mode of the actuator into a bending mode to generate sound. The piezoelectric speaker is essentially composed of two tightly coupled plate materials, presenting comparative advantage over thin-profile speakers required by the electronics. A piezoelectric speaker employs a metal plate as the vibrating diaphragm, making it difficult to generate low-frequency sound. Hence, high-pitched tone is generally found for the conventional piezoelectric speaker. In addition to compactness, improvement of low frequency range of sound and broadband applications are important issues of technical development of piezoelectric speakers.

With respect to relevant prior arts, such as prior art disclosed in JP3207199 and JP3143198 wherein the vibrating diaphragm is designed to bond the metal onto the flexible polymeric diaphragm, or disclosed in JP2000201399 wherein a viscoelastic body is applied, or disclosed in JP2228199 and JP2033300 wherein a flexible vibrating diaphragm is mated with a central support, the increase of total thickness will make sound not low enough in frequency response, and the sound pressure will also decline due to the lower rigidity of the vibrating diaphragm. Or, as disclosed in WO2007136162 wherein a damper is embedded into the metal to form a multi-layer vibrating diaphragm, the complex structure will lead to higher cost despite of little improvement of low frequency response. Or, as disclosed in JP200217195 and JP2005295339 wherein an elastic support is used to increase low frequency vibration of the vibrating diaphragm, and the compressive stress of the conductor against the vibrating diaphragm is improved, the higher complexity of structure makes it difficult for cost reduction. Or, as disclosed in JP3175800 wherein an elliptical actuator is mated with a vibrating diaphragm where a polymer vibrating diaphragm is applied, the fabrication difficulty is higher although the low frequency response can be extended. Or, as disclosed in JP7203591, JP2551813, U.S. Pat. No. 6,831,985 and JP2000333295 wherein a vibrating diaphragm of special shape is used to increase its equivalent area, or as disclosed in JP8088898 and JP2007194789 wherein the actuator is made of non-planar piezoelectric composite, there exist complex structure and fabrication as well as sound pressure reduction in spite of improved low frequency response.

To meet the requirement for broadband, the speaker shall have a broader acoustic frequency range, and almost the same sound pressure must be maintained to avoid excessive acoustic fluctuation. While a polymer vibrating diaphragm is used to improve low frequency response, it has relative weak response to high frequency, as disclosed in JP3082299 wherein highly rigid particles are added into polymer to improve insufficient high frequency response, or as disclosed in JP8084396 wherein a porous metal plate is employed to reduce its rigidity and raise the high-pitch sound. However, such a conventional piezoelectric speaker with a composite vibrating diaphragm has the shortcoming of insufficient bandwidth.

Alternatively, as disclosed in JP2001285994 and U.S.2010158283 wherein a damper is used to restrict the vibration amplitude of resonance and smooth down the frequency response of the vibrating diaphragm for broadband applications, the design complexity of multilayer structure still exists. Or, as disclosed in JP2279000, JP3139999, U.S. Pat. No. 5,828,768, JP3589873 and JP2003102094 wherein piezoelectric actuator is assembled onto the wall of the chamber for the electronics, the acoustic response of the chamber could be used to compensate the insufficient bandwidth. Yet, the amplitude is restricted by the bigger thickness of the chamber, leading to relatively low output of sound pressure.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

Based on the characteristics of the present invention wherein the vibrating diaphragm is fixed by piezoelectric bimorph actuator mounted onto a rigid frame. High sound pressure is generated by vibrating diaphragm through high deformation of the piezoelectric bimorph actuator in collaboration with the phase control of driving voltage for different actuators, this could adjust the vibration behavior and reduce the resonance of the vibrating diaphragm, such that the vibrating diaphragm could generate smooth acoustic response for broadband applications. Moreover, based on the high strain output of the piezoelectric bimorph actuator, the vibrating diaphragm could generate low frequency response of sound, making it an excellent structure of high sound pressure and low frequency performance. This can relax problem for the reduction of sound pressure affected by the damper, helping to form a piezoelectric panel speaker having low frequency response and broadband sound for thin-profile electronics.

Based on the structural configuration wherein two corresponding sides of the vibrating diaphragm spaced with said frame are linked to said frame via flexible connector, this could reduce the clamping effect of the frame against the vibrating diaphragm, and avoid the reduction of sound pressure arising from amplitude limitation of the vibrating diaphragm. Since the central part of the vibrating diaphragm is fixed by the flexible connector, this could avoid efficiently the asynchronous vibration from insufficient edge supporting, thus reducing the noise and distortion.

Based on the structural configuration wherein the piezoelectric actuator is fixed onto the frame to form a cantilevel beam, this could increase the vibration displacement of vibrating diaphragm during voltage driving, so as to yield high output of sound pressure.

Based on the structural configuration wherein said frame includes a plurality of frameworks to accommodate vibrating diaphragms of different length, the acoustic response of the entire piezoelectric panel speaker could be changed by varying the size of the vibrating diaphragms, such that the piezoelectric panel speaker could realize more stable acoustic response for broader acoustic applications.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a schematic view of the preferred embodiment of the piezoelectric panel speaker of the present invention.

FIG. 2 is a schematic view of the preferred embodiment of the piezoelectric bimorph actuator of the present invention.

FIG. 3 is a schematic view of the preferred embodiment of the piezoelectric bimorph plate of the present invention.

FIG. 4 is an acoustic response of the piezoelectric panel speaker when the flexible connector of the present invention employs flexible nylon nets.

FIG. 5 is a schematic view of another preferred embodiment of the piezoelectric bimorph actuator of the present invention.

FIG. 6 is a schematic view wherein the piezoelectric bimorph plates of the present invention are arranged at interval.

FIG. 7 is variations of acoustic responses for changing the driving voltage polarity of piezoelectric bimorph plates of the present invention.

FIG. 8 is a schematic view of the preferred embodiment of the present invention wherein the frame is shaped by a plurality of frameworks.

### DETAILED DESCRIPTION OF THE INVENTION

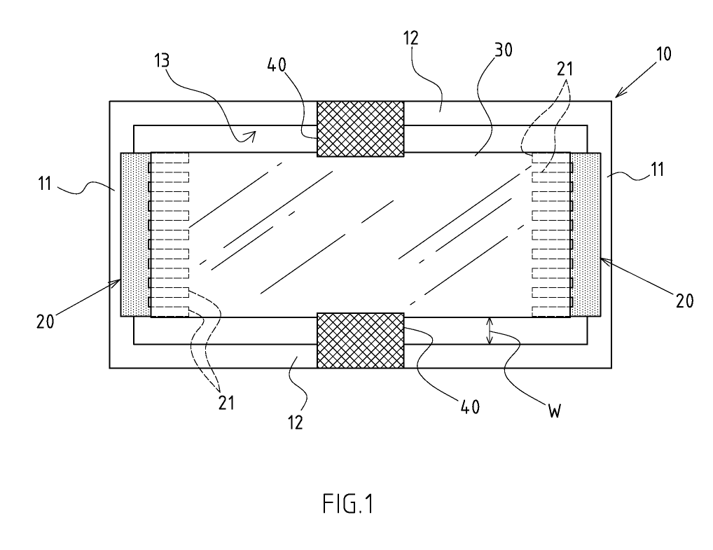

FIGS. 1-3 depict preferred embodiments of a piezoelectric panel speaker of the present invention, which, however, are provided for only explanatory objective for patent claims. Said piezoelectric panel speaker includes a frame 10, made of rigid substance (e.g.: plastics, metal, timber and ceramic), and defined to include several side frames 11, 12 as well as a space 13 formed between vibrating diaphragm and frames 11, 12. The frame 10 of the preferred embodiment is configured into a rectangular frame, or otherwise into polygonal and round frames.

Piezoelectric actuators 20 are assembled separately onto two side frames 11 of said frame 10. Each piezoelectric actuator 20 has multiple piezoelectric bimorph plates 21 arranged at interval.

A vibrating diaphragm 30 (or a diaphragm), which is a flexible polymeric diaphragm made of PI, PE, PEI, PET and PC plastic sheets, with its thickness of 20 μm-200 μm, is set into the frame 10. Two corresponding sides of the vibrating diaphragm 30 are fixed onto the piezoelectric bimorph plate 21 of the piezoelectric actuator 20, and the other two corresponding sides are spaced with the upper and lower side frames 12 of said frame 10 (marked by W in FIG. 1).

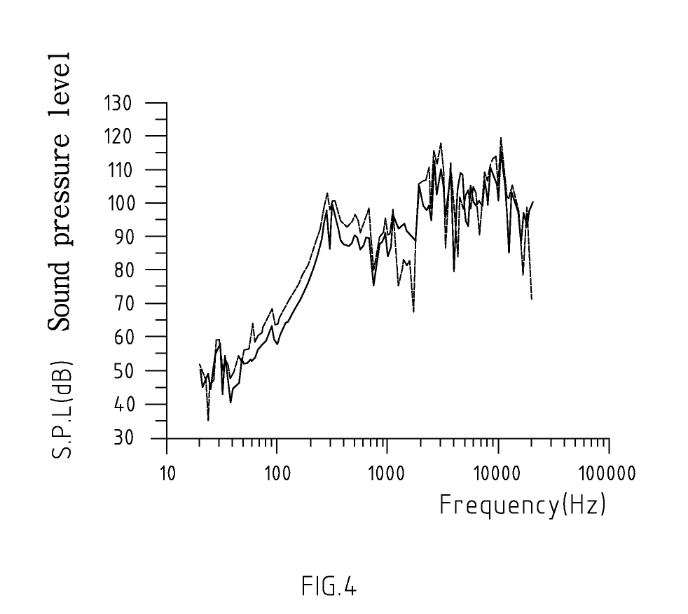

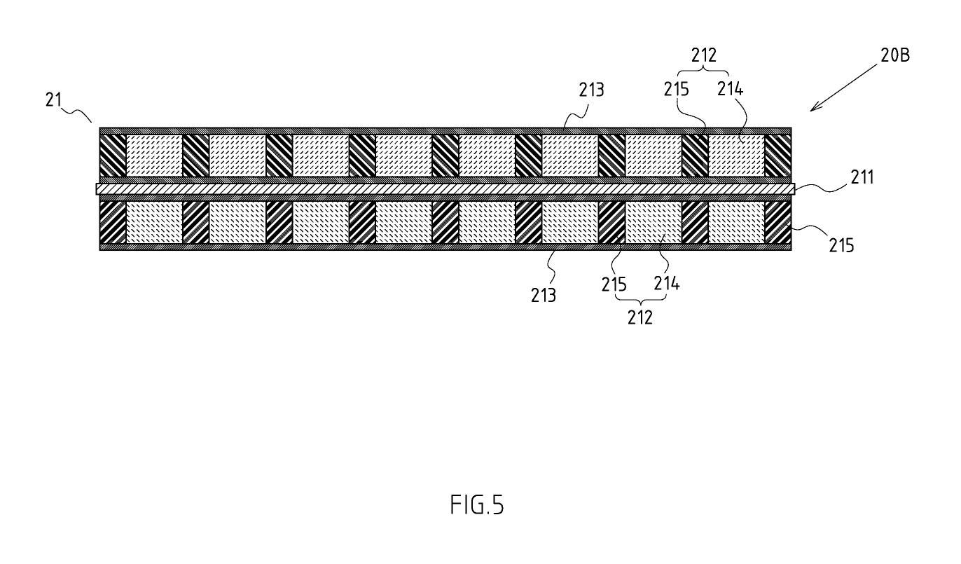

Referring to FIG. 1, two corresponding sides of the vibrating diaphragm 30 spaced with the side frame 12 of said frame 10 are linked to said frame 10 via locally distributed flexible connector 40 (number not limited). Said flexible connector 40 is made of nylon, silicone, rubber and silicone rubber nets or sheets. Of which, the preferred embodiment of the flexible connector 40 has a thickness of 50 μm-200 μm. With the setting of the flexible connector 40, the central part of the vibrating diaphragm 30 can be fixed robustly onto the frame 10, but its vibration is not limited. The flexible connector 40 is required when said frame 10 is extended longitudinally. Moreover, due to lack of lengthwise support for the vibrating diaphragm 30, sound pressure drop may occur near intermediate frequency (˜1 kHz) in the acoustic response. So, the flexible connector 40 could be used to prevent sound pressure loss at intermediate frequency, but also reduce the noise and phase distortion of sound arising from edge suspension of the vibrating diaphragm 30. Besides, when the flexible nylon connector 40 is used as a soft support, the acoustic response of the piezoelectric panel speaker is illustrated in FIG. 4 (marked by the curve with real line, otherwise marked by the curve with broken line), wherein the low-frequency sound pressure varies little, the medium-frequency sound pressure rises and the high-frequency sound pressure drops slightly. So, the flexible connector 40 could ensure more stable sound pressure output for the acoustic response. Of which, the starting frequency of rectangular vibrating diaphragm 30 is reduced, and the piezoelectric actuators 20 could generate low-frequency vibration to realize low-frequency sound.

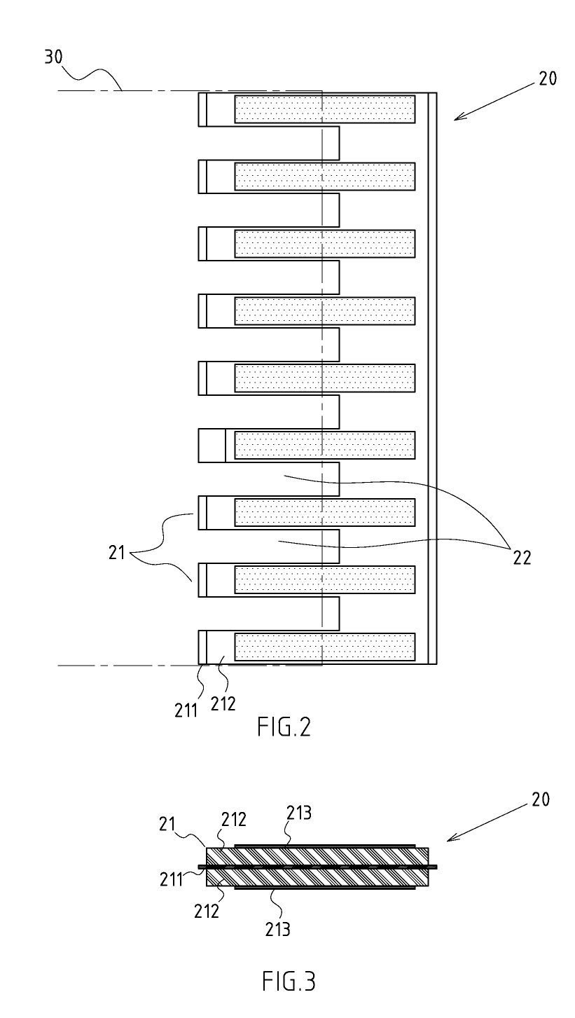

Referring to FIGS. 2 and 3, the piezoelectric actuator 20 is constructed in such a way that one side of the piezoelectric bimorph plate 21 is dissected into multiple parallel strip recesses 22 and becomes a comb-like shape. Each strip behaves as an independent cantilever with piezoelectric bimorph plate 21. Piezoelectric actuator 20 is formed with multiple piezoelectric bimorph plates 21, as illustrated in the preferred embodiment wherein the piezoelectric actuator 20 is cut into a comb-like shape. The thickness of the piezoelectric bimorph plate 21 is of 20 μm-200 μm. One end of the comb-like piezoelectric actuator 20 is fixed onto two side frames 11 of said frame 10 (in collaboration with FIG. 1) to form a cantilever structure, whilst the other end is bonded laterally onto the vibrating diaphragm 30, enabling vibration and acoustic generation of the vibrating diaphragm 30 under voltage driving. The piezoelectric actuators 20 are linked in parallel by circuits of the same driving voltage polarity, so as to drive the vibrating diaphragm 30 to generate maximum displacement, or the actuators in specific areas are linked by circuits of reverse driving voltage polarity, so as to reduce the resonance of vibrating diaphragm 30 at specific frequency for a broadband acoustic response. Through the design of reverse driving voltage polarity, the resonance of the vibrating diaphragm 30 could be reduced to generate smooth acoustic response.

Of which, the piezoelectric actuator 20 has piezoelectric bimorph vibrating plate, which may generate a specific resonance frequency depending on the size. So, the piezoelectric panel speaker has the sound generated by both the vibrating diaphragm 30 and piezoelectricity actuator 20.

Referring also to FIGS. 2 and 3, the piezoelectric bimorph plate 21 is formed in such a way that two piezoelectric plates 212 are separately adhered onto two opposite surfaces of a metal plate 211. The piezoelectric plates 212 are electrically connected in parallel. An electrode 213 is incorporated onto the surface of the piezoelectric plate 212. Moreover, the piezoelectric plate 212 is composed of piezoelectric ceramic or composite sheets. The preferred embodiment of the piezoelectric plate 212 has a thickness of 20 μm-200 μm.

When said piezoelectric actuator 20 is formed by bonding ceramic sheets onto the metal plate, high-pitched tone will be generated due to high rigidity. Hence, the piezoelectric panel speaker driven by the piezoelectric actuator 20 has enhanced high-frequency sound pressure. In order to improve high-frequency response of piezoelectric panel speaker, the piezoelectric bimorph actuator made from piezoelectric composites will be better. FIG. 5 illustrates a schematic view of another 1 piezoelectric bimorph actuator 20B, wherein the piezoelectric plate 212 adhered onto the metal plate 211 can be replaced by piezoelectric composites with high piezoelectricity. Said piezoelectric composites are composed of piezoelectric ceramic part 214 and organic polymer part 215 (e.g. resin). So, it can reduce the stiffness of the piezoelectric actuator 20B, resolve the extremely high sound pressure at high frequency range. Referring also to FIG. 5, the electrode 213 is directly adhered onto the piezoelectric plate 212 to ensure high piezoelectricity of the piezoelectric composites. The width ratio of piezoelectric ceramic part in the piezoelectric plate 212 refers to the content of piezoelectric phase in the piezoelectric composite sheets. A higher content means higher piezoelectricity of the piezoelectric composite sheet.

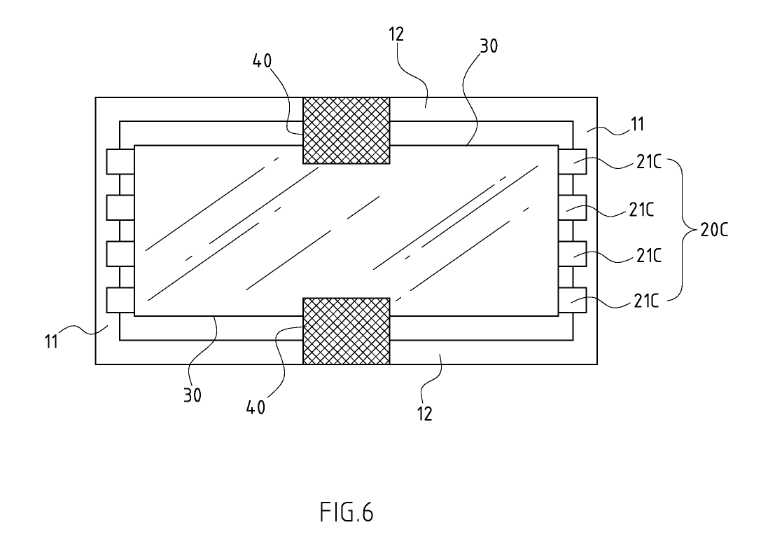

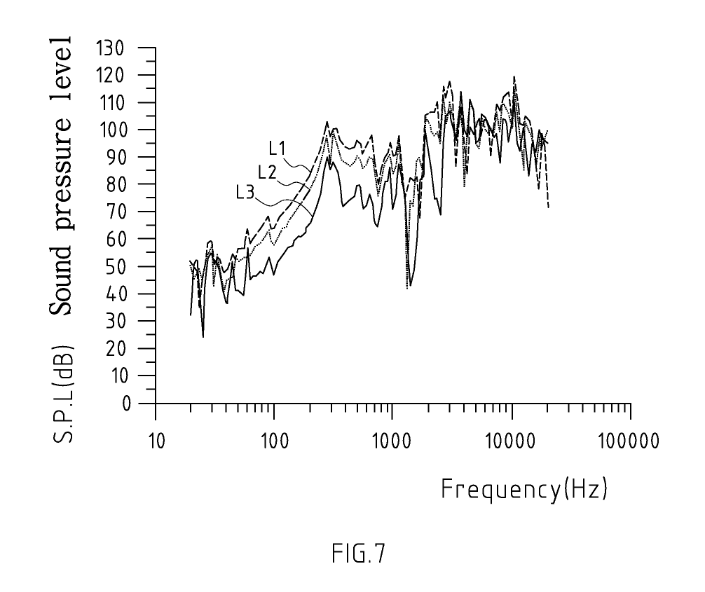

Referring to FIG. 6, the present invention can also employ piezoelectricity actuators 20C that are formed by several piezoelectric bimorph plates 21C arranged at interval, which can be used in collaboration with 100×50×0.1 mm³ PEI (i.e.: copolymer of PE and PI) vibrating diaphragm. The acoustic responses are illustrated in FIG. 7, wherein curve L1, L2, L3 represents separately the driving modes with 5 same phases, 4 same phases plus 1 reverse phase, and 3 same phases plus 2 reverse phases, respectively. The acoustic response can be changed through reverse driving voltage polarity of adjacent piezoelectric bimorph plates. The maximum sound pressure for overall acoustic response occurs when all piezoelectric bimorph plates are driven under the same phase. Since the piezoelectric bimorph plate of reverse phase is located at the central part, the low-frequency sound pressure is directly affected, but the high-frequency range is slightly changed by the variation of driving voltage. Under the driving of piezoelectric imorph plates with 5 same phases, the speaker has relatively high SPL (sound pressure level) at 300 Hz-20 kHz, and also showing that this structure could form a piezoelectric panel speaker with widebandth in acoustic response.

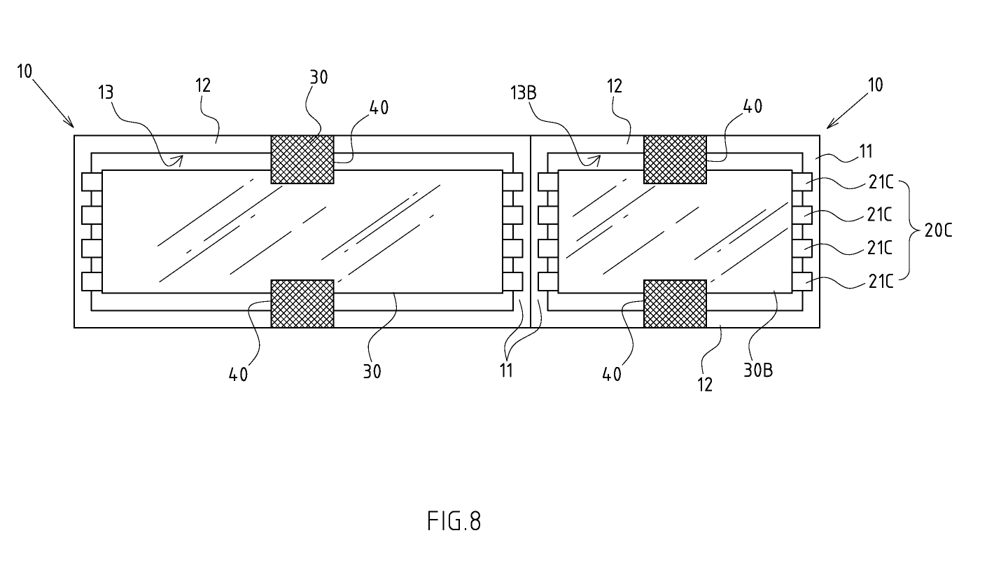

Referring to FIG. 8, said frame 10 also includes a plurality of frameworks defining a plurality of hollow assembly spaces 13, 13B of different length so as to accommodate vibrating diaphragms 30, 30B of different length. With this construction, different acoustic responses could be realized to obtain wide-bandwidth frequency response through these vibrating diaphragms 30, 30B. Specifically, the preferred embodiment allows to link the frames 10 of different length so as to form a long, narrow thin-profile piezoelectric panel speaker. With the vibrating diaphragms 30, 30B of different length as shown in the figure, the acoustic response of the entire piezoelectric panel speaker could be changed, such that a plurality of hollow assembly spaces 13, 13B and vibrating diaphragms 30, 30B could realize wider acoustic response for broader acoustic applications.

Additionally, the piezoelectric panel speaker can be applied to hi-fi, TV and computers, etc, and also assembled into the preset space of such electric appliances via its frame. Alternatively, the frame 10 of the piezoelectric panel speaker can be shaped by the structure of said electric appliances.

1. A piezoelectric panel speaker comprising:
a frame, defined to include several side frames as well as a hollow assembly space formed at center of the side frames;
piezoelectric actuators, assembled separately onto two side frames of said frame; each piezoelectric actuator having multiple piezoelectric bimorph plates arranged at interval;
a vibrating diaphragm, set into the hollow assembly space of the frame; two corresponding sides of the vibrating diaphragm are fixed onto the piezoelectric bimorph plate of the piezoelectric actuator, and the other two corresponding sides are spaced with said frame.

2. The structure defined in claim 1, wherein two corresponding sides of the vibrating diaphragm spaced with said frame are linked to said frame via a locally distributed flexible connector; said flexible connector is made of nylon, silicone, rubber and silicone rubber nets or sheets, with a thickness of 50 μm-200 μm.

3. The structure defined in claim 1, wherein said vibrating diaphragm has a thickness of 20 μm-200 μm.

4. The structure defined in claim 1, wherein said piezoelectric actuator is configured in such a way that one side of the piezoelectric bimorph plate is dissected into multiple parallel strip recesses, between which an independent cantilever piezoelectric bimorph plate is shaped to form a piezoelectric actuator with multiple piezoelectric bimorph plates.

5. The structure defined in claim 1, wherein said piezoelectric bimorph plate has a thickness of 20 μm-200 μm.

6. The structure defined in claim 1, wherein said piezoelectric bimorph plate is formed in such a way that two piezoelectric plates are separately adhered onto two opposite surfaces of a metal plate; the piezoelectric plates are electrically connected in parallel.

7. The structure defined in claim 6, wherein said piezoelectric plate is composed of piezoelectric ceramic or composite sheets, of which the piezoelectric plate has a thickness of 20 μm-200 μm.

8. The structure defined in claim 1, wherein said frame includes a plurality of frameworks defining a plurality of hollow assembly spaces; each hollow assembly space is set with different length to accommodate vibrating diaphragms of different length; with this configuration, different acoustic responses could be realized to obtain wide bandwidth frequency response through these vibrating diaphragms.

9. The structure defined in claim 1, wherein the piezoelectric panel speaker can be applied to hi-fi, TV and computers, etc, and also assembled into the preset space of such electric appliances via its frame.

10. The structure defined in claim 1, wherein the piezoelectric panel speaker can be applied to hi-fi, TV and computers, etc, and the frame of the piezoelectric panel speaker can be shaped by the structure of said electric appliances.
